(19) United States
(12) Patent Application Publication
(10) Pub. No.: US 2005/0172108 A1
(43) Pub. Date: Aug. 4, 2005

(54) Device and method of switching registers to be accessed by changing operating modes in a processor

(75) Inventor: Cheng-Yuh Wu, Renwu Township (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 10/995,390

(22) Filed: Nov. 24, 2004

(30) Foreign Application Priority Data
Feb. 4, 2004 (TW) 093102495

(51) Int. Cl. G06F 9/30

(52) U.S. Cl. 712/228

(57) ABSTRACT

A device and method of switching registers to be accessed by changing operating modes in a processor. The processor has a plurality of operating modes. The device has a register address decoder, at least one first register, a plurality of second registers and a selection device. The register address decoder decodes an instruction of the processor so as to generate a decoded output. The selection device selects one from the first register and the second registers for output based on the decoded output and an operating mode being executed by the processor.

### BACKGROUND OF THE INVENTION

1. Field of the Invention

The present invention relates to the technical field of processors and, more particularly, to a device and method of switching registers to be accessed by changing operating modes in a processor.

2. Description of Related Art

Conventionally, the number of registers to be accessed by a processor is limited by hardware (i.e., the bit length of a register addressing field in an instruction) as best illustrated in FIG. 1. The processor comprises a plurality of registers 11. For accessing one of the registers 11 by the processor, a decoder 12 decodes an instruction with a register address field in order to designate a register 11 specified by the register address field of the instruction. Next, the processor may access the designated register 11 via a multiplexer. However, the prior art suffered from a disadvantage in that the maximum number of the registers 11 to be accessed by the processor is limited to be 2^{P} where P is the length of the register address field. If it is desired to increase the number of registers available, the only solution is to increase the bit length of the register address field in the instruction set. However, this will decrease bits available for other fields such as operation field, immediate field, or the like in the instruction. This may adversely affect the function of the instruction. Further, for a processor with defined instruction set, it is not practical to arbitrarily change the bit length of any field due to compatibility. Therefore, it is understood that the known processor cannot meet the need of increasing the number of registers to be accessed. Thus, the need for improvement still exists.

### SUMMARY OF THE INVENTION

An object of the present invention is to provide a device and method of switching registers to be accessed by changing operating modes in a processor in order to obviate the aforementioned problem.

In one aspect of the present invention, there is provided a device of switching registers to be accessed by changing operating modes in a processor, comprising: a register address decoder for decoding an instruction of the processor so as to generate a decoded output; at least one first register; a plurality of second registers; and a selection device for selecting one from the first register and the second registers for output based on the decoded output and an operating mode being executed by the processor.

In another aspect of the present invention, there is provided a method of switching registers to be accessed by changing operating modes in a processor including at least one first register and a plurality of second registers, comprising the steps of: (A) decoding an instruction of the processor for generating a decoded output; and (B) selecting one from the first register and the second registers for output based on the decoded output and an operating mode being executed by the processor.

In yet another aspect of the present invention, there is provided an device of switching registers to be accessed by changing operating modes in a processor, comprising: a register address decoder for decoding an instruction of the processor so as to generate a decoded output; at least one first register; a plurality of second registers; and a selection device for selecting one from the second registers and a combination of a portion of a second register and the first register for output based on the decoded output and an operating mode being executed by the processor.

In a further aspect of the present invention, there is provided a method of switching registers to be accessed by changing operating modes in a processor including at least one first register and a plurality of second registers, comprising the steps of: (A) decoding an instruction of the processor for generating a decoded output; and (B) selecting one from the second registers and a combination of a portion of a second register and the first register for output based on the decoded output and an operating mode being executed by the processor.

Other objects, advantages, and novel features of the present invention will become more apparent from the detailed description when taken in conjunction with the accompanying drawings.

### BRIEF DESCRIPTION OF THE DRAWINGS

FIG. 1 schematically depicts a conventional technique of addressing a register in a processor;

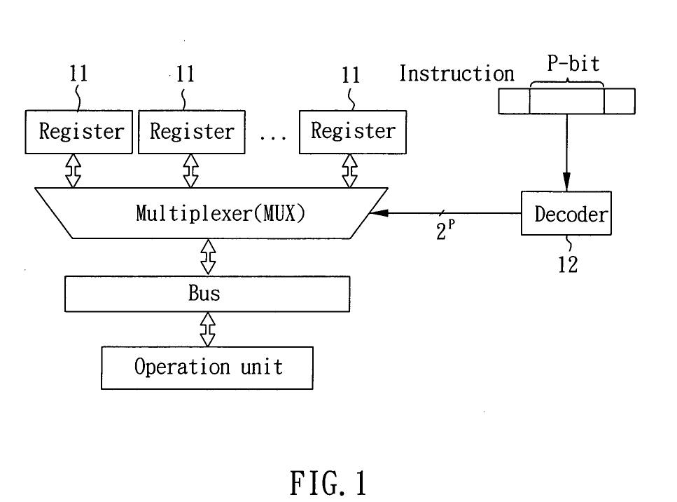

FIG. 2 schematically depicts a first embodiment of switching registers to be accessed by changing operating modes in a processor in accordance with the present invention; and

FIG. 3 schematically depicts a second embodiment of switching registers to be accessed by changing operating modes in a processor in accordance with the present invention.

### DETAILED DESCRIPTION OF THE PREFERRED EMBODIMENT

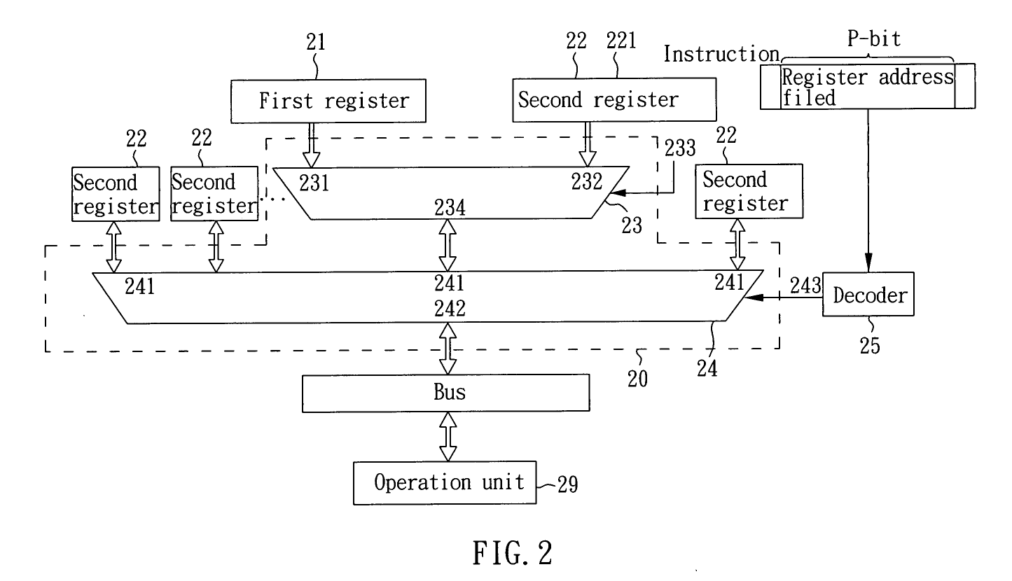

With reference to FIG. 2, there is shown the device of switching registers to be accessed by changing operating modes in a processor in accordance with a preferred embodiment of the present invention. The device includes at least one first register 21, a plurality of second registers 22, a selection device 20, and a decoder 25. The decoder 25 is adapted to decode an instruction sent from the processor for generating a decoded output. In the instruction set, the instruction for accessing registers has a P-bit register address field. The processor is thus able to designate a register to be accessed based on the decoded register address field and an operating mode being executed, so as to read and place data of the designated register into the system bus for being processed by an operation unit or write data to the designated register via the system bus.

The selection device 20 includes a first multiplexer 23 and a second multiplexer 24. The selection device 20 is adapted to select one from the first register 21 and the second registers 22 for data output based on the decoded output and the operating mode being executed by the processor. In this embodiment, the processor is adapted to execute in one of a user mode, a kernel mode, and a debug mode. The number of the second registers 22 corresponds to the bit length of the register address field in the instruction. For example, the number of the second register 22 is 2^{P} if the register address field is P-bit long. One of the second registers 22 (e.g., the second register 221) and the first register 21 are coupled to a first connecting terminal 231 and a second connecting terminal 232 of the first multiplexer 23 respectively. A control terminal 233 of the first multiplexer 23 is adapted to connect the first connecting terminal 231 or the second connecting terminal 232 to a selection terminal 234 of the first multiplexer 23 based on the operating mode being executed by the processor.

The second multiplexer 24 includes a plurality of connecting terminals 241, a selection terminal 242, and a control terminal 243 for selectively connecting one of the connecting terminals 241 to the selection terminal 242. The connecting terminals 241 are coupled to the selection terminal 234 of the first multiplexer 23 and all second registers 22 except the second register 221. The control terminal 243 of the second multiplexer 24 is coupled to the output of the decoder 25. The decoder 25 decodes the register address field of an instruction, so as to control the second multiplexer 24 to connect one of the connecting terminals 241 to the selection terminal 242.

With the above structure, the decoder 25 decodes the register address field of an instruction to select one of the connecting terminals 241 to connect with the selection terminal 242, and the connecting terminals 241 are connect to the selection terminal 234 of the first multiplexer 23 and all second registers 22 except the second register 221 respectively. Therefore, the register to be accessed depends on the first multiplexer 23 when the decoded output from the decoder 25 selects the connecting terminal 241 connected to the selection terminal 234 of the first multiplexer 23 to connect with the selection terminal 242. That is, the processor accesses the first register 21 when the first connecting terminal 231 of the first multiplexer 23 is coupled to the selection terminal 234 thereof; otherwise, the processor accesses the second register 221 when the second connecting terminal 232 of the first multiplexer 23 is coupled to the selection terminal 234 thereof. Because the first multiplexer 23 is controlled by the operating mode of the processor being executed, the processor is able to access different registers by referring to the same register address in different operating modes, so as to achieve the purpose of switching registers by changing the operating modes being executed by the processor and thus increase the number of registers to be accessed.

With reference to FIG. 2 again, in this embodiment, the control terminal 233 is adapted to couple the second connecting terminal 232 of the first multiplexer 23 to the selection terminal 234 thereof when the processor is executed in a kernel mode or user mode. As a result, the processor is adapted to access only the second register 221, not the first register 21. In other words, data contained in the first register 21 cannot be manipulated (i.e., protected) when the processor is executing in the kernel mode or user mode. On the contrary, the control terminal 233 is adapted to couple the first connecting terminal 231 of the first multiplexer 23 to the selection terminal 234 thereof when the processor is executing in a debug mode. As a result, the processor is able to access the first register 21. The first register 21 may be stored with, for example, a processor ID for a debugging program. Therefore, it is able to not only increase the number of registers to be accessed but also provide ID information to a specific program being executed for achieving the functions of software identification and protection.

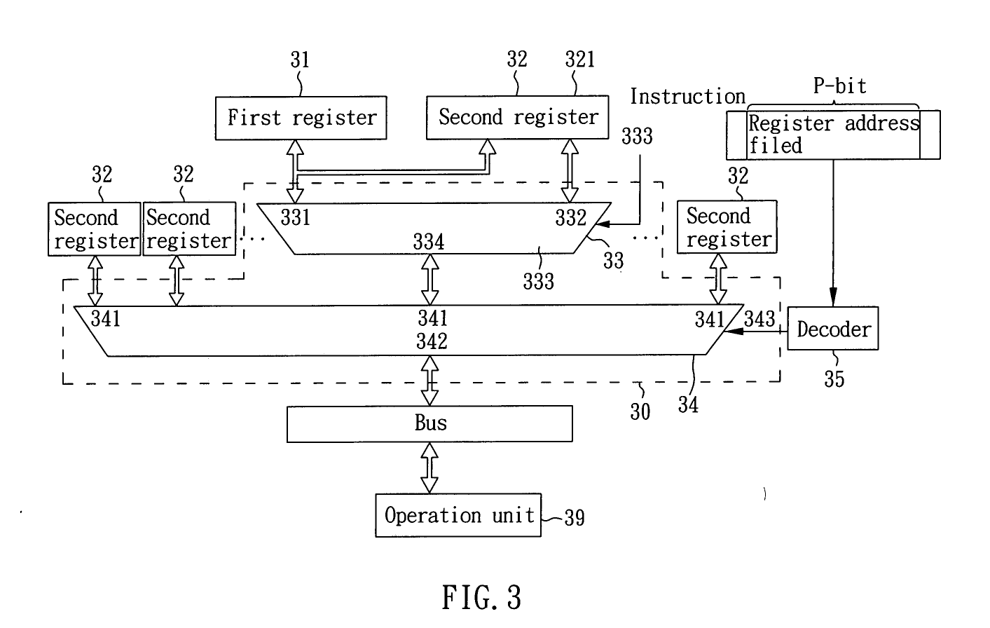

With reference to FIG. 3, there is shown the device of switching registers to be accessed by changing operating modes in a processor in accordance with another preferred embodiment of the present invention. This embodiment is similar to the previous one in including a first register 31, a plurality of second registers 32, a selection device 30 having a first multiplexer 33 and a second multiplexer 34, and a decoder 35, except that the first connecting terminal 332 of the first multiplexer 33 is connected to one of the second registers 32 (e.g., the second register 321), and the second connecting terminal 331 of the first multiplexer 33 is connected to the first register 31 and a portion of the second register 321 connected to the first connecting terminal 332 of the first multiplexer 33, so that the selection device 30 is able to select one from the second registers 32 and the combination of a portion of the second register 321 and the first register 31 based on the decoded output and the operating mode being executed by the processor. That is, the processor accesses the second register 321, but not the first register 31, when there processor is in the kernel mode or user mode and the control terminal 333 is adapted to couple the second connecting terminal 332 of the first multiplexer 33 to the selection terminal 334 thereof. On the contrary, the processor is able to access the combination of a portion of the second register 321 and the first register 31 when the processor is in the debug mode and the control terminal 333 is adapted to couple the first connecting terminal 331 of the first multiplexer 33 to the selection terminal 334 thereof. Accordingly, this embodiment also can increase the number of registers to be accessed and provide ID information to a specific program being executed for achieving the functions of software identification and protection.

In view of the foregoing, it is known that the present invention is adapted to switch registers to be accessed by changing the operating modes in a processor. The processor of the present invention is thus able to access different registers by referring to the same register address in different operating modes. As an end, the purpose of increasing the number of registers to be accessed can be obtained. Further, the designated register only can be accessed in a specific operating mode so as to prevent data stored in a register from being manipulated by an unauthorized party in a general operating mode.

Although the present invention has been explained in relation to its preferred embodiment, it is to be understood that many other possible modifications and variations can be made without departing from the spirit and scope of the present invention as hereinafter claimed.

1. A device of switching registers to be accessed by changing operating modes in a processor, comprising:
a register address decoder for decoding an instruction of the processor so as to generate a decoded output;
at least one first register;
a plurality of second registers; and
a selection device for selecting one from the first register and the second registers for output based on the decoded output and an operating mode being executed by the processor.

2. The device as claimed in claim 1, wherein the selection device is operative to select one of the second registers based on the decoded output and is operative to determine whether to select the at least one first register to replace one of the second registers based on the operating mode being executed by the processor.

3. The device as claimed in claim 1, wherein the selection device comprises:
at least one first multiplexer for selecting one from the first register and the second registers for output based on the operating mode being executed by the processor; and
a second multiplexer for selecting one from the second registers and an output of the first multiplexer for output based on the decoded output.

4. The device as claimed in claim 1, wherein the operating modes comprise a user mode, a kernel mode, and a debug mode.

5. The device as claimed in claim 4, wherein the selection device is operative to select the second register when the processor is executing in the kernel mode or the user mode.

6. The device as claimed in claim 4, wherein the selection device is operative to select the first register to replace the second register when the processor is executing in the debug mode.

7. A method of switching registers to be accessed by changing operating modes in a processor including at least one first register and a plurality of second registers, comprising the steps of:
(A) decoding an instruction of the processor for generating a decoded output; and
(B) selecting one from the first register and the second registers for output based on the decoded output and an operating mode being executed by the processor.

8. The method as claimed in claim 7, wherein the step (B) comprises:
(B1) selecting one of the second registers based on the decoded output; and
(B2) determining whether to select the at least one first register to replace one of the second registers based on the operating mode being executed by the processor.

9. The method as claimed in claim 7, wherein the operating modes comprise a user mode, a kernel mode, and a debugging mode.

10. The method as claimed in claim 9, wherein in step (B2), the second register is selected when the processor is executing in the kernel mode or the user mode.

11. The method as claimed in claim 9, wherein in step (B2), the first register is selected when the processor is executing in the debug mode.

12. A device of switching registers to be accessed by changing operating modes in a processor, comprising:
a register address decoder for decoding an instruction of the processor so as to generate a decoded output;
at least one first register;
a plurality of second registers; and
a selection device for selecting one from the second registers and a combination of a portion of a second register and the first register for output based on the decoded output and an operating mode being executed by the processor.

13. The device as claimed in claim 12, wherein the selection device is operative to select one of the second registers based on the decoded output and is operative to determine whether to select the combination of a portion of the second register and the first register to replace the second register based on the operating mode being executed by the processor.

14. The device as claimed in claim 12, wherein the selection device comprises:
at least one first multiplexer for selecting one from the second registers and the combination of a portion of the second register and the first register for output based on the operating mode being executed by the processor; and
a second multiplexer for selecting one of the second registers and an output of the first multiplexer for output based on the decoded output.

15. The device as claimed in claim 12, wherein the operating modes comprise a user mode, a kernel mode, and a debugging mode.

16. The device as claimed in claim 15, wherein the selection device is operative to select the second register when the processor is executing in the kernel mode or the user mode.

17. The device as claimed in claim 15, wherein the selection device is operative to select the combination of a portion of the second register and the first register when the processor is executing in the debug mode.

18. A method of switching registers to be accessed by changing operating modes in a processor including a first register and a plurality of second registers, comprising the steps of:
(A) decoding an instruction of the processor for generating a decoded output; and
(B) selecting one from the second registers and a combination of a portion of a second register and the first register for output based on the decoded output and an operating mode being executed by the processor.

19. The method as claimed in claim 18, wherein the step (B) comprises:
(B1) selecting one of the second registers based on the decoded output; and
(B2) determining whether to select the combination of a portion of the second register and the first register to replace the second register based on the operating mode being executed by the processor.

20. The method as claimed in claim 19, wherein the operating modes comprise a user mode, a kernel mode, and a debug mode.

21. The method as claimed in claim 20, wherein in step (B2), the second register is selected when the processor is executing in the kernel mode or the user mode.

22. The method as claimed in claim 20, wherein in step (B2), the combination of a portion of the second register and the first register is selected to replace the second register when the processor is executing in the debug mode.
